(19) United States
(12) Patent Application Publication
(10) Pub. No.: US 2007/0274760 A1
(43) Pub. Date: Nov. 29, 2007

(54) Cartridge case

(75) Inventor: Zenko Motoki, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/514,403

(22) Filed: Aug. 29, 2006

(30) Foreign Application Priority Data
May 23, 2006 (JP) 2006-143153
May 23, 2006 (JP) 2006-143156

(51) Int. Cl. B41J 17/32

(52) U.S. Cl. 400/693.1; 400/208

(57) ABSTRACT

A first pressing member, which is in the form of a leaf spring, is disposed within a gap between a second support-side sidewall and a support shaft of a feed bobbin included in an ink-sheet unit. A second pressing member, which is in the form of a leaf spring, is disposed within a gap between the second support-side sidewall and a support shaft of a take-up bobbin included in the ink-sheet unit. The pressing members are in contact with ends of the support shafts of the feed bobbin and the take-up bobbin so as to bias the feed bobbin and the take-up bobbin towards a second drive-side sidewall. The pressing members are integrated with the second support-side sidewall.

### BACKGROUND OF THE INVENTION

1. Field of the Invention

The present invention relates to cartridge cases, and particularly, to a cartridge case that houses an ink-sheet unit used in printers.

2. Description of the Related Art

As a typical printer that quickly performs printing on recording paper in a line-by-line fashion or page-by-page fashion, a line thermal printer is known. A line thermal printer includes a long thermal head having heater elements arranged in the width direction of recording paper. Such a line thermal printer has an ink-sheet cartridge installed therein, which includes a cartridge case that houses an ink-sheet unit.

An ink-sheet unit includes a long ink sheet having coloring regions coated with, for example, yellow ink, magenta ink, and cyan ink, a tubular feed bobbin around which the ink sheet is wound from one end thereof, and a tubular take-up bobbin around which the ink sheet is wound from the other end thereof.

The feed bobbin and the take-up bobbin are defined by substantially cylindrical components composed of resin. Each of the bobbins includes a tubular base portion disposed at the waist section thereof, a drive shaft disposed at a first end of the base portion, and a support shaft disposed at a second end of the base portion. The base portion and the drive shaft of the feed bobbin have a collar flange disposed therebetween. Similarly, the base portion and the drive shaft of the take-up bobbin have a collar flange disposed therebetween.

The cartridge case includes a top wall facing a top face of the ink-sheet unit, a bottom wall facing a bottom face of the ink-sheet unit, a drive-side sidewall located at a position facing the drive shafts disposed at the first ends of the feed bobbin and the take-up bobbin, and a support-side sidewall located at a position facing the support shafts disposed at the second ends of the feed bobbin and the take-up bobbin. The cartridge case also includes inner walls disposed at positions facing inner faces of the drive-side sidewall and the support-side sidewall. The inner walls are separated from the corresponding inner faces by predetermined gaps and extend parallel to the inner faces. The inner walls are provided with shaft bearings for rotatably supporting the drive shafts and the support shafts of the feed bobbin and the take-up bobbin.

Such a cartridge case includes a first case component and a second case component, which are composed of, for example, synthetic resin. The two case components are joined to each other by, for example, ultrasonic welding.

Japanese Unexamined Patent Application Publication No. 5-155122 discloses an example of the ink-sheet cartridge described above, in which the cartridge case houses the ink-sheet unit in a rotatable fashion with the feed bobbin and the take-up bobbin serving as shafts.

In this example of ink-sheet cartridge, the cartridge case contains pressing members defined by compression coil springs composed of metal. When the ink-sheet unit is housed within the cartridge case, each of the pressing members is disposed within a gap between an end of the support shaft of the feed bobbin or the take-up bobbin and the support-side sidewall.

Each pressing member is in contact with the end of the corresponding support shaft so as to bias the feed bobbin or the take-up bobbin towards the drive-side sidewall. Thus, the outer faces of the flanges of the feed bobbin and the take-up bobbin are in pressure-contact with the inner wall that faces the inner face of the drive-side sidewall. Consequently, this prevents the feed bobbin and the take-up bobbin from rotating idly within the cartridge case and thus inhibits the ink sheet from sagging inside the cartridge case.

However, in the cartridge case included in the ink-sheet cartridge of the known example described above, because the pressing members for preventing idle rotation of the feed bobbin and the take-up bobbin are composed of metal whereas the cartridge case is composed of a synthetic resin material, the pressing members to be installed in the cartridge case need to be manufactured as separate components from the cartridge case. This complicates the manufacturing process of the cartridge case and leads to an increase in manufacturing costs. Moreover, when the cartridge case is to be discarded, the pressing members have to be removed from the cartridge case, which is time consuming and is problematic from an environmental viewpoint.

Furthermore, with regard to the shaft bearings for rotatably supporting the support shafts of the feed bobbin and the take-up bobbin, the installation accuracy of the feed bobbin and the take-up bobbin may vary depending on the dimensional accuracy of the shaft bearings, and moreover, the degree of frictional resistance against the support shafts is large. This may lead to inconsistent feed and take-up processes of the ink sheet, thus resulting in low print quality.

### SUMMARY OF THE INVENTION

Accordingly, it is an object of the present invention to provide a cartridge case included in an ink-sheet cartridge, which can be manufactured readily at reduced cost. It is another object of the present invention to provide a cartridge case included in an ink-sheet cartridge, which requires less time when the cartridge case is to be discarded. Furthermore, it is another object of the present invention to provide a cartridge case included in an ink-sheet cartridge, which inhibits the installation accuracy of support shafts of a feed bobbin and a take-up bobbin from varying and which allows for a reduction in frictional resistance against the support shafts so that feed and take-up processes of an ink sheet can be carried out smoothly, thereby contributing to high print quality.

The present invention provides a cartridge case that houses a detachable ink-sheet unit, the ink-sheet unit including a feed bobbin around which an ink sheet is wound from one end thereof and a take-up bobbin around which the ink sheet is wound from the other end thereof. The cartridge case includes a drive-side sidewall located at a position facing drive shafts disposed at first ends of the feed bobbin and the take-up bobbin; and a support-side sidewall located at a position facing support shafts disposed at second ends of the feed bobbin and the take-up bobbin. The support-side sidewall is integrally provided with a pressing member. The pressing member is in contact with an end of the support shaft of at least one of the feed bobbin and the take-up bobbin included in the ink sheet unit so as to bias the at least one of the feed bobbin and the take-up bobbin towards the drive-side sidewall.

According to the cartridge case of the present invention, the pressing member is formed integrally with the drive-side sidewall and the support-side sidewall using a resin material. Therefore, in contrast to the known example described above in which a pressing member is composed of a different material and is a separate component from the cartridge case, the present invention does not require a step for attaching the pressing member to the cartridge case. In addition, when the cartridge case is to be discarded, it is not necessary to remove the pressing member from the cartridge case.

Furthermore, the cartridge case according to the present invention may further include an inner wall at a position facing an inner face of the support-side sidewall and separated from the support-side sidewall by a predetermined gap. The inner wall may be provided with a shaft bearing on an edge thereof, the shaft bearing rotatably supporting the support shaft from one side. The pressing member may be integrally provided with a holding segment, the holding segment and the shaft bearing holding the support shaft therebetween.

Accordingly, the holding segment provided in the pressing member and the shaft bearing hold the support shaft therebetween. Thus, at least one of the feed bobbin and the take-up bobbin can be secured in position, thereby preventing the at least one of the feed bobbin and the take-up bobbin from being displaced within the cartridge case.

Furthermore, in the cartridge case according to the present invention, the cartridge case may be defined by a first case component and a second case component. In this case, the support-side sidewall may include a first support-side sidewall included in the first case component and a second support-side sidewall included in the second case component. In addition, the cartridge case may further include an inner wall located at a position facing an inner face of the first support-side sidewall and separated from the first support-side sidewall by a predetermined gap. The inner wall may be provided with a shaft bearing on an edge thereof. The shaft bearing may have a projection provided therein.

Accordingly, the feed bobbin or the take-up bobbin can be secured in position, and the installation accuracy of the feed bobbin and the take-up bobbin is inhibited from varying, which may be due to the dimensional accuracy of the shaft bearing. In addition, since frictional resistance against the support shafts can be reduced, the feed and take-up processes of the ink sheet can be carried out smoothly, thereby contributing to high print quality.

As described above, the present invention does not require a step for attaching the pressing member to the cartridge case. This contributes to a simplified manufacturing process of the cartridge case and eliminates the need for manufacturing the pressing member as a separate component from the cartridge case, thereby achieving a reduction in manufacturing cost. In addition, when the cartridge case is to be discarded, it is not necessary to remove the pressing member from the cartridge case. Accordingly, this advantageously saves time when the cartridge case is discarded.

Furthermore, since the installation accuracy of the support shafts can be inhibited from varying and the frictional resistance against the support shafts can be reduced, the feed and take-up processes of the ink sheet can be carried out smoothly, thereby contributing to high print quality.

### BRIEF DESCRIPTION OF THE DRAWINGS

FIG. 1 is an exploded perspective view of an ink-sheet cartridge equipped with a cartridge case according to the present invention;

FIG. 2 is an enlarged view showing a relevant portion of the cartridge case included in the ink-sheet cartridge shown in FIG. 1; and

FIG. 3 is a cross-sectional view showing a relevant portion of the ink-sheet cartridge shown in FIG. 1.

### DESCRIPTION OF THE PREFERRED EMBODIMENTS

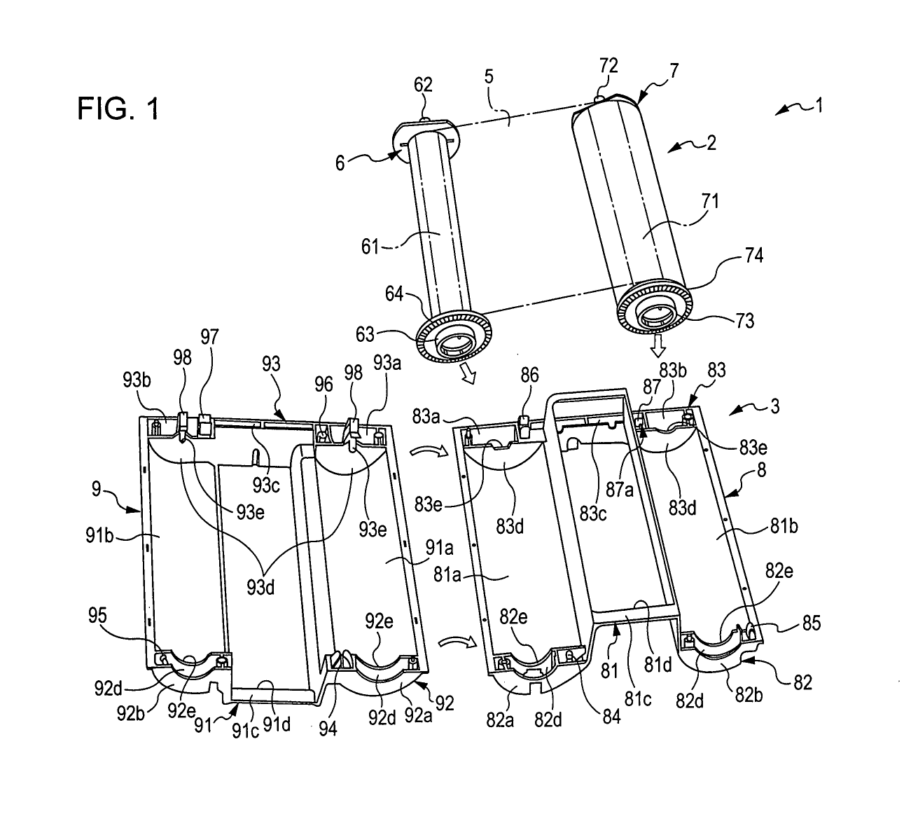

An ink-sheet cartridge equipped with a cartridge case according to an exemplary embodiment of the present invention will now be described with reference to FIGS. 1 to 3.

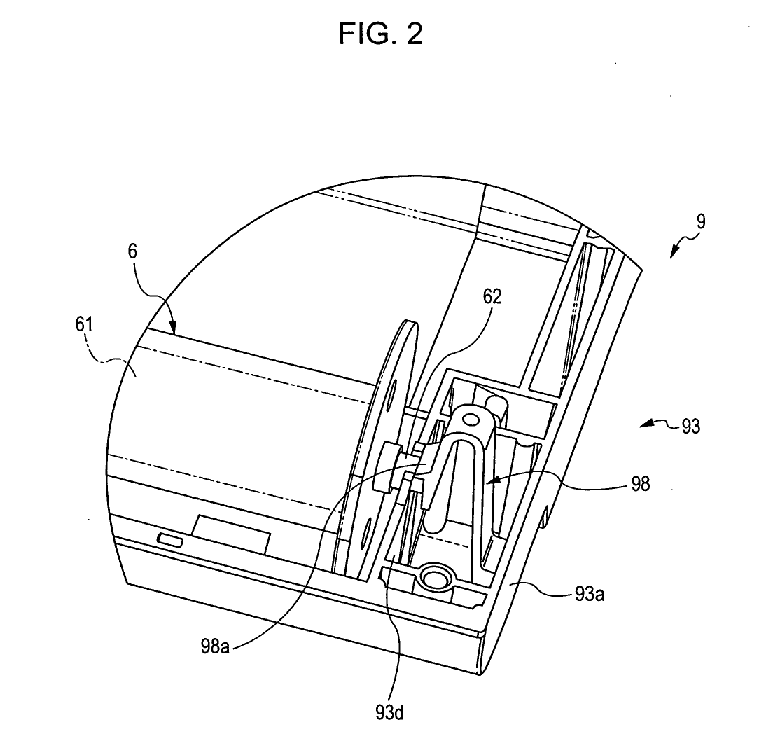

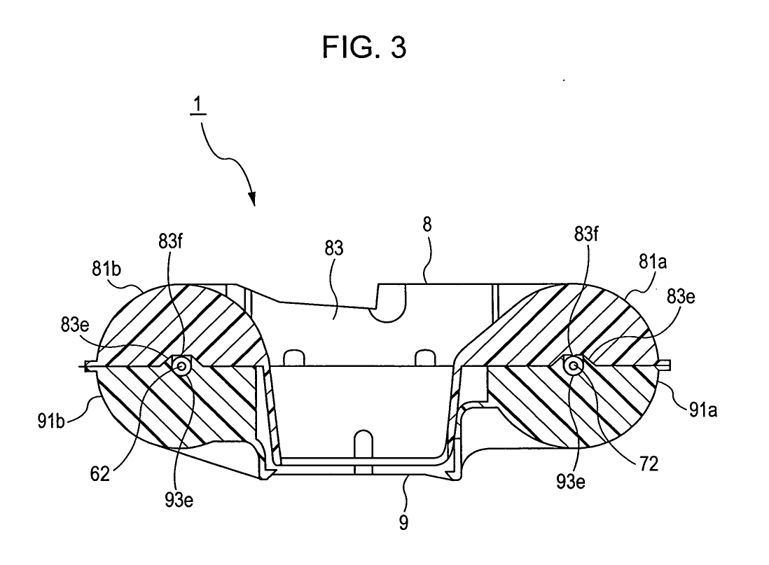

FIG. 1 is an exploded perspective view of an ink-sheet cartridge 1 according to this embodiment. FIG. 2 is an enlarged view showing a relevant portion of a cartridge case 3 included in the ink-sheet cartridge 1 shown in FIG. 1. FIG. 3 is a cross-sectional view showing a relevant portion of the ink-sheet cartridge 1 shown in FIG. 1.

Referring to FIG. 1, the ink-sheet cartridge 1 according to this embodiment includes an ink-sheet unit 2 and the cartridge case 3 housing the ink-sheet unit 2 in a detachable fashion.

The ink-sheet unit 2 includes a long ink sheet 5 having coloring regions coated with yellow (Y) ink, magenta (M) ink, and cyan (C) ink in a predetermined order, a feed bobbin 6 around which the ink sheet 5 is wound from one end thereof, and a take-up bobbin 7 around which the ink sheet 5 is wound from the other end thereof.

The feed bobbin 6 and the take-up bobbin 7 in the ink-sheet unit 2 are defined by substantially cylindrical components composed of resin and respectively include tubular base portions 61, 71 disposed at the waist sections thereof, drive shafts 63, 73 disposed at first ends of the base portions 61, 71, and support shafts 62, 72 disposed at second ends of the base portions 61, 71. The drive shafts 63, 73 have a diameter that is larger than the external diameter of the base portions 61, 71. On the other hand, the support shafts 62, 72 have a diameter that is smaller than the external diameter of the base portions 61, 71. The base portion 61 and the drive shaft 63 of the feed bobbin 6 have a collar flange 64 disposed therebetween. Similarly, the base portion 71 and the drive shaft 73 of the take-up bobbin 7 have a collar flange 74 disposed therebetween.

An unused portion of the ink sheet 5 is wound around the base portion 61 of the feed bobbin 6 from one end of the ink sheet 5. The base portion 71 of the take-up bobbin 7 takes up the ink sheet 5 from the other end thereof. The drive shafts 63, 73 are connected to a printer driving system (not shown) that applies a rotational driving force to the feed bobbin 6 and the take-up bobbin 7. Thus, the rotational driving force is transmitted to the feed bobbin 6 and the take-up bobbin 7 via the drive shafts 63, 73.

The cartridge case 3 includes a first resin case component 8 and a second resin case component 9 that can be combined with each other in a detachable fashion.

Referring to FIG. 1, the first case component 8 has a bottom wall 81 facing a bottom face of the ink-sheet unit 2, a first drive-side sidewall 82 extending vertically from one side of the bottom wall 81, and a first support-side sidewall 83 extending vertically from the other side of the bottom wall 81. Specifically, the first drive-side sidewall 82 is located at a position facing lower half portions of the drive shafts 63, 73 disposed at the first ends of the feed bobbin 6 and the take-up bobbin 7. Likewise, the first support-side sidewall 83 is located at a position facing lower half portions of the support shafts 62, 72 disposed at the second ends of the feed bobbin 6 and the take-up bobbin 7.

The bottom wall 81 includes a semi-cylindrical feed portion 81a at a position facing a bottom face of the portion of the ink sheet 5 wound around the feed bobbin 6, a semi-cylindrical take-up portion 81b at a position facing a bottom face of the portion of the ink sheet 5 wound around the take-up bobbin 7, and a link portion 81c that links the feed portion 81a and the take-up portion 81b. A midsection of the link portion 81c is provided with a window-like opening 81d through which the ink sheet 5 extending between the feed bobbin 6 and the take-up bobbin 7 is exposed.

The first drive-side sidewall 82 includes a semi-circular feed portion 82a at a position facing the drive shaft 63 of the feed bobbin 6, and a semi-circular take-up portion 82b at a position facing the drive shaft 73 of the take-up bobbin 7. The feed portion 82a and the take-up portion 82b have U-shaped cutouts on the edges thereof. The drive shafts 63, 73 are exposed through these cutouts. Furthermore, the first case component 8 includes inner walls 82d disposed at positions facing inner faces of the feed portion 82a and the take-up portion 82b of the first drive-side sidewall 82. The inner walls 82d are separated from the inner faces of the feed portion 82a and the take-up portion 82b by a predetermined gap and extend parallel to the inner faces. The inner walls 82d have U-shaped cutouts on the edges thereof, such that the cutouts serve as lower shaft bearings 82e for rotatably supporting the drive shafts 63, 73 of the feed bobbin 6 and the take-up bobbin 7.

The feed portion 82a and the take-up portion 82b of the first drive-side sidewall 82 are respectively provided with engagement claws 84, 85 used for detachably combining the first case component 8 and the second case component 9.

The first support-side sidewall 83 includes a feed portion 83a at a position facing the support shaft 62 of the feed bobbin 6, a take-up portion 83b at a position facing the support shaft 72 of the take-up bobbin 7, and a link portion 83c that links the feed portion 83a and the take-up portion 83b. Furthermore, the first case component 8 also includes semi-circular inner walls 83d disposed at positions facing inner faces of the feed portion 83a and the take-up portion 83b of the first support-side sidewall 83. The inner walls 83d are separated from the inner faces of the feed portion 83a and the take-up portion 83b by a predetermined gap and extend parallel to the inner faces. The inner walls 83d have U-shaped cutouts on the edges thereof, such that the cutouts serve as lower shaft bearings 83e for rotatably supporting the support shafts 62, 72 of the feed bobbin 6 and the take-up bobbin 7. Each of the lower shaft bearings 83e has a projection 83f provided therein.

The feed portion 83a and the take-up portion 83b of the first support-side sidewall 83 are respectively provided with engagement claws 86, 87 used for detachably combining the first case component 8 and the second case component 9.

The second case component 9 has a top wall 91 facing a top face of the ink-sheet unit 2, a second drive-side sidewall 92 extending vertically from one side of the top wall 91, and a second support-side sidewall 93 extending vertically from the other side of the top wall 91. Specifically, the second drive-side sidewall 92 is located at a position facing upper half portions of the drive shafts 63, 73 of the feed bobbin 6 and the take-up bobbin 7. Likewise, the second support-side sidewall 93 is located at a position facing upper half portions of the support shafts 62, 72 of the feed bobbin 6 and the take-up bobbin 7.

The top wall 91 includes a semi-cylindrical feed portion 91a at a position facing a top face of the portion of the ink sheet 5 wound around the feed bobbin 6, a semi-cylindrical take-up portion 91b at a position facing a top face of the portion of the ink sheet 5 wound around the take-up bobbin 7, and a link portion 91c that links the feed portion 91a and the take-up portion 91b. A midsection of the link portion 91c is provided with a window-like opening 91d through which the ink sheet 5 extending between the feed bobbin 6 and the take-up bobbin 7 is exposed.

The second drive-side sidewall 92 includes a semi-circular feed portion 92a at a position facing the drive shaft 63 of the feed bobbin 6, and a semi-circular take-up portion 92b at a position facing the drive shaft 73 of the take-up bobbin 7. The feed portion 92a and the take-up portion 92b have U-shaped cutouts on the edges thereof. The drive shafts 63, 73 are exposed through these cutouts. Furthermore, the second case component 9 also includes inner walls 92d disposed at positions facing inner faces of the feed portion 92a and the take-up portion 92b of the second drive-side sidewall 92. The inner walls 92d are separated from the inner faces of the feed portion 92a and the take-up portion 92b by a predetermined gap and extend parallel to the inner faces. The inner walls 92d have U-shaped cutouts on the edges thereof, such that the cutouts serve as upper shaft bearings 92e for rotatably supporting the drive shafts 63, 73 of the feed bobbin 6 and the take-up bobbin 7.

The feed portion 92a and the take-up portion 92b of the second drive-side sidewall 92 are respectively provided with engagement claws 94, 95 which face the engagement claws 84, 85 provided in the feed portion 82a and the take-up portion 82b of the first drive-side sidewall 82 when the first case component 8 and the second case component 9 are disposed facing each other.

The second support-side sidewall 93 includes a feed portion 93a at a position facing the support shaft 62 of the feed bobbin 6, a take-up portion 93b at a position facing the support shaft 72 of the take-up bobbin 7, and a link portion 93c that links the feed portion 93a and the take-up portion 93b. The feed portion 93a and the take-up portion 93b of the second support-side sidewall 93 have a double-walled structure. Furthermore, the second case component 9 also includes inner walls 93d disposed at positions facing inner faces of the feed portion 93a and the take-up portion 93b of the second support-side sidewall 93. The inner walls 93d are separated from the inner faces of the feed portion 93a and the take-up portion 93b by a predetermined gap and extend parallel to the inner faces. The inner walls 93d have U-shaped cutouts on the edges thereof, such that the cutouts serve as upper shaft bearings 93e for rotatably supporting the support shafts 62, 72 of the feed bobbin 6 and the take-up bobbin 7.

A first pressing member 98, which is in the form of a leaf spring, is disposed within the gap between the feed portion 93a of the second support-side sidewall 93 and one of the inner walls 93d and is located at a position facing the end of the support shaft 62 of the feed bobbin 6. Likewise, a second pressing member 98, which is in the form of a leaf spring, is disposed within the gap between the take-up portion 93b of the second support-side sidewall 93 and the other inner wall 93d and is located at a position facing the end of the support shaft 72 of the take-up bobbin 7. Each of the pressing members 98 extends from the inner face of the second support-side sidewall 93, is bent towards the first case component 8, and is bent again towards the second drive-side sidewall 92 by a sharp angle. Thus, an end portion of the first pressing member 98 and an end portion of the second pressing member 98 respectively come into contact with the support shaft 62 of the feed bobbin 6 and the support shaft 72 of the take-up bobbin 7 when the ink-sheet unit 2 is housed within the cartridge case 3.

Referring to FIG. 2, the end portion of each pressing member 98 is provided with a holding segment 98a, which protrudes from the pressing member 98 towards the second drive-side sidewall 92. The support shaft 62 of the feed bobbin 6 and the support shaft 72 of the take-up bobbin 7, which are rotatably supported by the upper shaft bearings 93e of the inner walls 93d, are held between the holding segments 98a and the upper shaft bearings 93e.

The pressing members 98 and the holding segments 98a are formed integrally with the top wall 91, the second drive-side sidewall 92, and the second support-side sidewall 93 using a synthetic resin material.

Each pressing member 98 has its end portion in contact with the end of the support shaft 62 or support shaft 72. The pressing members 98 bias the feed bobbin 6 and the take-up bobbin 7 towards the second drive-side sidewall 92 so that the outer faces of the flanges 64, 74 of the feed bobbin 6 and the take-up bobbin 7 are in pressure-contact with the inner walls 82d facing the first drive-side sidewall 82 and the inner walls 92d facing the second drive-side sidewall 92. Accordingly, this prevents the feed bobbin 6 and the take-up bobbin 7 from rotating idly and thus inhibits the ink sheet 5 from sagging inside the cartridge case 3. Furthermore, since the support shafts 62, 72 are held between the holding segments 98a of the pressing members 98 and the upper shaft bearings 93e, the feed bobbin 6 and the take-up bobbin 7 can be secured in position, thereby preventing the support shafts 62, 72 from being displaced from the corresponding upper shaft bearings 93e.

Furthermore, the feed portion 93a and the take-up portion 93b of the second support-side sidewall 93 are respectively provided with engagement claws 96, 97 which face the engagement claws 86, 87 provided in the feed portion 83a and the take-up portion 83b of the first support-side sidewall 83 when the first case component 8 and the second case component 9 are disposed facing each other.

The first case component 8 and the second case component 9 are combined with each other by engaging the engagement claws 84, 85, 86, 87 of the first drive-side sidewall 82 and the first support-side sidewall 83 respectively with the engagement claws 94, 95, 96, 97 of the second drive-side sidewall 92 and the second support-side sidewall 93. In this case, the support shafts 62, 72 of the feed bobbin 6 and the take-up bobbin 7 are held between the upper shaft bearings 93e of the second case component 9 and the projections 83f provided in the lower shaft bearings 83e of the first case component 8.

The advantages of this embodiment will now be described.

According to this embodiment, the end portions of the pressing members 98 disposed between the inner faces of the second support-side sidewall 93 and the inner walls 93d are in contact with the ends of the support shafts 62, 72, whereby the feed bobbin 6 and the take-up bobbin 7 are biased towards the drive-side sidewalls 82, 92. This prevents free rotation of the feed bobbin 6 and the take-up bobbin 7. Furthermore, the pressing members 98 are formed integrally with the top wall 91, the second drive-side sidewall 92, and the second support-side sidewall 93 using a resin material.

Consequently, a step for attaching the pressing members 98 to the cartridge case 3, for example, can be omitted, thereby facilitating the manufacturing process of the cartridge case 3. In addition, the pressing members 98 do not need to be manufactured as separate components from the cartridge case 3, thereby contributing to lower manufacturing costs. Furthermore, when the cartridge case 3 is to be discarded, it is not necessary to remove the pressing members 98 from the cartridge case 3. Accordingly, this advantageously saves time when the cartridge case 3 is discarded.

Furthermore, the pressing members 98 are provided with the holding segments 98a for holding the support shafts 62, 72 together with the upper shaft bearings 93e. Consequently, since the support shafts 62, 72 are held between the upper shaft bearings 93e and the holding segments 98a, the feed bobbin 6 and the take-up bobbin 7 can be secured in position, thereby preventing the feed bobbin 6 and the take-up bobbin 7 from being displaced within the cartridge case 3.

Furthermore, because the support shafts 62, 72 of the feed bobbin 6 and the take-up bobbin 7 are also held between the upper shaft bearings 93e of the second case component 9 and the projections 83f provided in the lower shaft bearings 83e of the first case component 8, the installation accuracy of the feed bobbin 6 and the take-up bobbin 7 is inhibited from varying, which may be dependant upon the dimensional accuracy of the upper shaft bearings 93e and the lower shaft bearings 83e. In addition, since frictional resistance against the support shafts 62, 72 can be reduced, the feed and take-up processes of the ink sheet 5 can be carried out smoothly, thereby contributing to high print quality.

The technical scope of the present invention is not limited to the above embodiment, and modifications are permissible within the scope and spirit of the present invention.

For example, the shape of the pressing members 98 for pressing the support shafts 62, 72 is not limited to the shape described in the above embodiment and may be arbitrarily determined. Furthermore, although the projections 83f are provided in the lower shaft bearings 83e of the first case component 8, the same effect can be achieved by, for example, providing the projections 83f alternatively in the upper shaft bearings 93e of the second case component 9.

What is claimed is:

1. A cartridge case housing a detachable ink-sheet unit, the ink-sheet unit including a feed bobbin around which an ink sheet is wound from one end thereof and a take-up bobbin around which the ink sheet is wound from the other end thereof, the cartridge case comprising:
a drive-side sidewall located at a position facing drive shafts disposed at first ends of the feed bobbin and the take-up bobbin; and
a support-side sidewall located at a position facing support shafts disposed at second ends of the feed bobbin and the take-up bobbin,
wherein the support-side sidewall is integrally provided with a pressing member, the pressing member being in contact with an end of the support shaft of at least one of the feed bobbin and the take-up bobbin included in the ink sheet unit so as to bias said at least one of the feed bobbin and the take-up bobbin towards the drive-side sidewall.

2. The cartridge case according to claim 1, further comprising an inner wall at a position facing an inner face of the support-side sidewall and separated from the support-side sidewall by a predetermined gap,
wherein the inner wall is provided with a shaft bearing on an edge thereof, the shaft bearing rotatably supporting said support shaft from one side, and
wherein the pressing member is integrally provided with a holding segment, the holding segment and the shaft bearing holding said support shaft therebetween.

3. The cartridge case according to claim 1, wherein the cartridge case comprises a first case component and a second case component,
wherein the support-side sidewall comprises a first support-side sidewall included in the first case component and a second support-side sidewall included in the second case component,
wherein the cartridge case further comprises an inner wall located at a position facing an inner face of the first support-side sidewall and separated from the first support-side sidewall by a predetermined gap,
wherein the inner wall is provided with a shaft bearing on an edge thereof, and
wherein the shaft bearing has a projection provided therein.
